(19) United States
(12) Patent Application Publication
(10) Pub. No.: US 2015/0275564 A1
(43) Pub. Date: Oct. 1, 2015

(54) GARAGE DOOR OPERATOR ACCESSORY

(71) Applicants: Avi Rosenthal, San Diego, CA (US); Duane Paulson, Carlsbad, CA (US)

(72) Inventors: Avi Rosenthal, San Diego, CA (US); Duane Paulson, Carlsbad, CA (US)

(21) Appl. No.: 14/591,593

(22) Filed: Jan. 7, 2015

Related U.S. Application Data
(60) Provisional application No. 61/973,702, filed on Apr. 1, 2014.

(51) Int. Cl. E05F 15/77; H04W 4/00; G05B 15/02

(52) U.S. Cl. CPC E05F 15/77; G05B 15/02; H04W 4/008; E05Y 2400/45; E05Y 2400/44; E05Y 2400/30; E05Y 2400/818; E05Y 2400/85; E05Y 2900/106

(57) ABSTRACT

Systems, devices, and methods according to the present disclosure can be used to control or automate operation of a barrier door using a transceiver device and a barrier door operator. In an example, the transceiver device includes a wireless communication circuit that receives door operation instructions from a remote control device. The transceiver device includes a data communication link to provide a control signal to a terminal of a barrier door operator, such as a terminal configured to interface with a pushbutton. One or more sensors can be integrated with, or in data communication with, the transceiver device to influence operation of the barrier door. For example, using environment information from a sensor located near the transceiver device, the transceiver device can determine whether to open or close the barrier door. In some examples, the transceiver device receives or communicates barrier door operation information via a network.

### CLAIM OF PRIORITY

This application claims the benefit of priority under 35 U.S.C. §119(e) of U.S. Provisional Patent Application Ser. No. 61/973,702, filed on Apr. 1, 2014, which is herein incorporated by reference in its entirety.

### BACKGROUND

A barrier operator device, such as a garage door or gate operator device, can be configured to automatically open, close, lock, unlock, or change a characteristic of a door or barrier in response to a triggering event. The triggering event can include a command from a user, and the command can be transmitted to the barrier operator device via a wired or wireless medium.

Conventional automatic garage door operator devices, or garage door openers, are electromechanical devices that are configured to raise and lower a garage door in response to a command signal. The command signal can be an electrical pulse signal transmitted to the door operator by way of a pushbutton switch through physical wires, or the command signal can be a radio signal transmitted by way of a battery-operated remote control. The command signal can be received at a control circuit for the door operator, and the control circuit can initiate movement of a garage door to a state that is opposite from a state in which the door resides when the command signal is received. That is, if the garage door is open, then the command signal can cause the control circuit to close the garage door, and if the garage door is closed, then the command signal can cause the control circuit to open the garage door.

Home automation or electronic security systems can be used to control or monitor electronic devices around a home. For example, a home automation system can use a wired or wireless network to communicate with one or more appliances, utilities, sensors, displays, or other devices using a home automation protocol. Many electrical and electronic appliances in a home have programmable and network-ready circuitry and interfaces, and such appliances can be connected to a home network for use in controlling a home environment. For example, lighting, temperature, sound, automatic doors, or other characteristics of the home environment can be updated or changed using the home automation system. Some commercially available network systems use a proprietary protocol to interface devices with an automation system to control the devices. Such interfaces and networks can exclude or can be nonfunctional with devices that are not operable using the same proprietary protocol.

### Overview

The present inventor has recognized, among other things, that a problem to be solved includes enabling communication between a barrier door operator and a home automation system. The present subject matter can help provide a solution to this problem by providing systems and methods for using a hardware interface device to receive a control signal from a control device that is optionally a portion of a home automation system, interpret the control signal, and then conditionally provide the same or different control signal to a barrier door operator.

In an example, the present subject matter includes a transceiver device with a wireless communication circuit that is configured to receive a door operation instruction from a control device that is remote from the transceiver device. The control device can include a remote control device, a smartphone, or a home automation system controller, among other things. The transceiver device can include a data output terminal configured to provide a control signal to a wired terminal of the barrier door operator, and the wired terminal of the barrier door operator can be normally configured to be coupled with a remote pushbutton device. When the control signal is received by the barrier door operator, the barrier door operator can be caused to open or close a barrier door.

In an example, the present subject matter includes a method for wirelessly controlling a barrier door using a transceiver device that is communicatively coupled to a barrier door operator. The method can include wirelessly receiving an instruction at a transceiver device, from a wireless remote control device, to open or close the barrier door, and receiving barrier door position information from a tilt sensor. The method can include communicating an instruction to open or close the barrier door to the barrier door operator, and the communicated instruction can be based on the received instruction from the control device and the received barrier door position information from the tilt sensor. In an example, communicating the instruction to open or close the barrier door includes providing an electrical signal via a wired connection from the transceiver device to a pair of electrical terminals located on the barrier door operator. The pair of electrical terminals located at the barrier door operator can be conventionally configured to receive a barrier door control signal from a wired pushbutton.

The present inventor has recognized, among other things, that a mobile smart device such as a smartphone can be used to interface with smart/connected home devices (e.g., Z-wave enabled home devices), and related TCP/IP network infrastructure can be used to control a barrier door operator, such as to remotely operate a garage door or other barrier door in a home. Using the present subject matter, the barrier door operator can be considered a device and the garage can be considered a zone to be monitored or controlled remotely as a part of a home automation system. Embodiments of the present subject matter can include a garage door opener accessory that can be used to retrofit a conventional pushbutton barrier door operator for remote control or monitoring.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a perspective view of a portion of a system that includes a barrier door operator and a transceiver device for controlling the barrier door operator.

FIG. 2 illustrates generally an example of a wiring diagram that includes a barrier door operator and a transceiver device for controlling the barrier door operator.

FIG. 3A illustrates generally an example of a system that includes a transceiver device wired in parallel with an external device.

FIG. 3B illustrates generally an example of a system that includes a transceiver device wired in series with an external device.

FIG. 4 illustrates generally an example of a block diagram of a system that includes a transceiver device and multiple sensors.

FIG. 5 illustrates generally an example of a state diagram for a barrier door operator system.

FIG. 6 illustrates generally an example of a method that includes operating a barrier door using information from a transceiver.

FIG. 7 illustrates generally an example of a method that includes operating a barrier door using sensor information.

### DETAILED DESCRIPTION

This detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of the elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the claims, the terms “including” and “comprising” are open-ended, that is, a system, device, article, composition, formulation, or process that includes elements in addition to those listed after such a term in a claim are still deemed to fall within the scope of that claim. Moreover, in the claims, the terms “first,” “second,” and “third,” etc. are used merely as labels, and are not intended to impose numerical requirements on their objects.

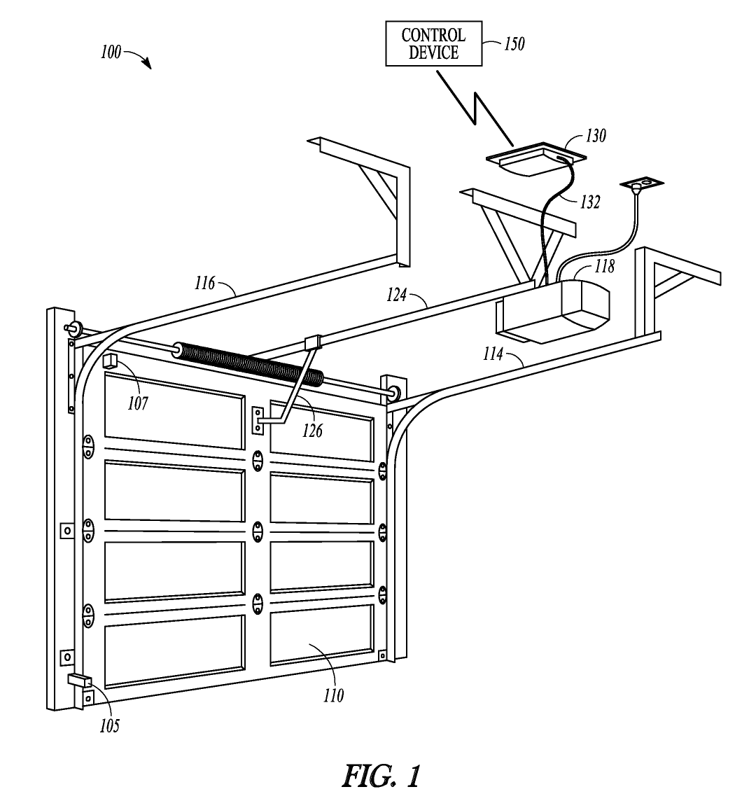

FIG. 1 illustrates generally an example of a perspective view of a portion of a system 100 that includes a barrier door 110 and a barrier door operator 118. The system 100 further includes a transceiver device 130 for controlling the barrier door operator 118. In the example of FIG. 1, the barrier door 110 is an overhead multi-section type garage door that is supported for movement between opened and closed positions by a set of rollers that are movable in stationary tracks 114 and 116 at opposite sides of the door.

The barrier door operator 118 is a powered device that includes a reversible electric drive motor (not shown), and the barrier door operator 118 can be mounted substantially above the barrier door 110 when the barrier door 110 is in a closed configuration. The barrier door operator 118 can be coupled with the barrier door 110 using a chain, belt or screw-driven carrier 126 that is movable along a track 124 to adjust the overhead position of the barrier door 110. Other barrier door operators with fundamentally different theories of operation can be similarly used in coordination with the transceiver device 130 described herein. For example, a barrier door operator that translates a gate substantially horizontally can be similarly used with the transceiver device 130 according to the systems and methods of the present disclosure.

The barrier door 110 can be moved between substantially open and substantially closed positions, or any position in between, by selectively energizing the drive motor using a local or remote actuator. In an example, a local actuator includes a pushbutton type single-pole switch that can be coupled with control circuitry for the drive motor via one or more wires. In response to actuation of the pushbutton type single-pole switch, such as to open or close an electrical circuit that includes the switch, an electrical signal (or absence of an electrical signal) can be received at the barrier door operator 118 to initiate or terminate operation of the drive motor. In an example, the drive motor can be activated by a conventional wireless door opener, or remote transmitter, having an actuator. Upon actuation, the remote transmitter can be caused to generate and transmit a coded radio frequency signal (or other wireless signal) to a receiver circuit on-board the barrier door operator 118. In an example, the local or remote actuator includes a button on a touch-screen display and, in response to a user-actuation of a designated portion of the touch-screen display, the control signal can be transmitted to the barrier door operator 118.

To supplement or replace the local or remote actuator described above, the system 100 includes the transceiver device 130 for controlling the barrier door operator 118. That is, the transceiver device 130 can be used exclusively to control the barrier door operator 118, or the transceiver device 130 can be used to supplement control of the barrier door operator 118 that is otherwise provided using the local actuator (e.g., wired pushbutton) or remote actuator (e.g., wireless remote transmitter) described above. The transceiver device 130 can receive operating instructions for the barrier door operator 118 from a user by way of a control device 150. In an example, the control device 150 is a dedicated barrier door control device, and in other examples, the control device 150 is a portion or feature of a device that is used as a portion of a home automation system.

As used herein, the term “home automation system” includes any device, module, or other component that can communicate with one or more other devices, modules, or other components such as appliances, utilities, sensors, displays, or other systems using a home automation system protocol. In some examples, a “home automation system” refers to a home security system or other system that can be used to process information about devices in or around a home.

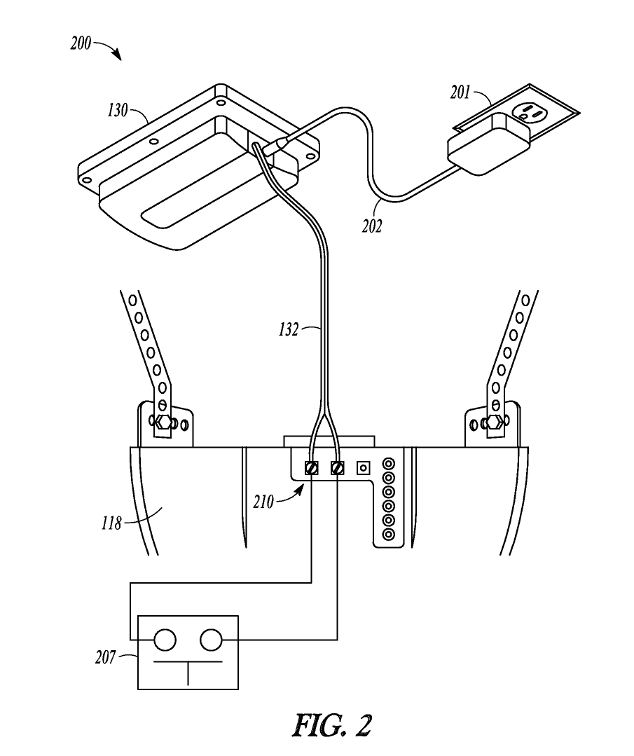

The transceiver device 130 can be coupled to the barrier door operator 118 using a wired connection 132 (see, e.g., FIG. 2). The transceiver device 130 can optionally be wirelessly coupled to the barrier door operator 118 in examples where the barrier door operator 118 is configured to receive instructions using a wireless signal receiver. In an example, the transceiver device 130 receives a barrier door control signal from a remote device, such as other than the remote transmitter that is configured to interface directly with the barrier door operator 118. In response to the barrier door control signal from the remote device, the transceiver device 130 can provide a control signal to the barrier door operator 118 using the wired connection 132 or using a wireless connection. In an example, in response to receiving the barrier door control signal, the transceiver device 130 can provide an electrical signal to, or remove an electrical signal from, terminals on the barrier door operator 118, such as to mimic the operation of the local actuator described above.

In an example, a barrier door control signal is issued from the transceiver device 130 to the barrier door operator 118 in response to a signal from the control device 150. The control device 150 is communicatively coupled to the transceiver device 130 using a wired or wireless connection. In an example, the control device 150 includes a Z-Wave compatible controller, such as can be programmed with an appropriate command class, such as the Iris Home Automation System. In an example of such a configuration, the control device can communicate with the transceiver device 130, or with one or more other portions of a home automation system, using the Z-Wave wireless protocol. In an example, the control device 150 can be configured to communicate using one or more other communication protocols such as Zigbee, Near-Field Communication, Bluetooth, Bluetooth Low Energy, IP, WiFi, or other protocol.

In an example, the transceiver device 130 includes two or more separate radio devices, such as can be communicatively coupled to a central processor circuit in the device. The central processor circuit can be configured to perform a bridging function such as between the two or more radio devices. In an example, using the multiple radio devices enables long-range communication between the device and one or more sensors while also enabling communication with a communication hub of a home automation system. In an example, using the multiple radio devices provides favorable power consumption, range, and/or one or more other characteristics that may not be otherwise possible with a single wireless protocol, such as Z-Wave, which is designed for high traffic applications.

In the example of FIG. 1, an obstruction sensor 105 is positioned near the bottom of the stationary track 116. The obstruction sensor 105 can be an optical sensor that is configured to sense the presence of any obstruction near the ground and, in response, provide an electrical signal to the barrier door operator 118 to influence its operation. For example, if an obstruction is present, then the obstruction sensor 105 can provide a signal to the barrier door operator 118 to halt, reverse, or slow movement of the barrier door 110. If no obstruction is present, then the barrier door operator 118 can freely open or close the barrier door 110.

In the example of FIG. 1, a tilt sensor 107 is coupled to the barrier door 110. The tilt sensor 107 can include an accelerometer, optical sensor, or other sensor configured to receive location or visual information about the barrier door 110. Information from the tilt sensor 107 can optionally be used by the barrier door operator 118 to verify a position of the barrier door 110.

In an example, information from the obstruction sensor 105 or the tilt sensor 107 can be provided to or received at the transceiver device 130. The transceiver device 130 can use the information to control the barrier door operator 118, or the transceiver device 130 can communicate the information to a home automation system module or other device. For example, the transceiver device 130 can receive a “close door” barrier door control signal from a remote device and the transceiver device 130 can receive tilt information from the tilt sensor 107. If the tilt information indicates that the barrier door 110 is already in a closed position, then the transceiver device 130 can screen the “close door” command and provide no signal to the barrier door operator 118. If the tilt information indicates that the barrier door 110 is in an open position, then the transceiver device 130 can communicate the “close door” command to the barrier door operator 118. In an example, if the tilt information indicates that the barrier door 110 is moving, then the transceiver device 130 can hold the “close door” command for a specified delay duration and, when the tilt information indicates that the barrier door 110 is stationary, the transceiver device 130 can determine whether to screen or communicate the “close door” instruction to the barrier door operator 118.

The transceiver device 130 can be used to extend or broaden a distance from which a user can configure or operate the barrier door 110. In an example, the transceiver device 130 can communicate with a central communication hub, such as can be a portion of a home automation system, for communicating with and coordinating various home automation devices or tasks. The central communication hub can enable a remote user to communicate with the hub and with the transceiver device 130 using a wide area network, such as the internet. The remote user can obtain status or other operation information about the barrier door, including information about various conditions in the environment near the barrier door using one or more sensors, or the remote user can operate the barrier door or update programming or rules associated with one or more barrier door operations or functions.

In an example, the transceiver device 130 can conform to one or more operational constraints or rules. For example, the device can be configured so as to not interfere with one or more existing barrier-door safety mechanisms. In an example, the transceiver device 130 can include one or more other or additional safety features, such as described herein, such as to include a feature for remote operation from a greater distance than in a conventional, wirelessly-operated barrier door system. In an example, the transceiver device 130 can be configured to issue one or more visual and/or audible alarms and/or alerts, such as before a barrier door moves, or the transceiver device 130 can be configured to use sensed feedback information, such as to verify the operation of a safety mechanism. In an example, the transceiver device 130 can include processor-implemented logic configured to inhibit or prevent operation of a barrier door in the event that a portion of the system is indicated to be malfunctioning or absent.

FIG. 2 illustrates generally an example of a wiring diagram 200 that includes the barrier door operator 118 and the transceiver device 130 for controlling the barrier door operator 118. The transceiver device 130 is a powered device and is plugged into an electrical outlet 201 using a transceiver power cord 202. In other examples, the transceiver device 130 can be battery powered.

The barrier door operator 118 includes a pair of electrical terminals 210 that are configured to be selectively electrically coupled with a pushbutton 207. In the example of FIG. 2, the pushbutton 207 is a normally-open single-pole switch that, upon actuation, electrically shunts its two terminals. When the pushbutton 207 is actuated, the electrical terminals 210 are shunted, and in response, the drive motor of the barrier door operator 118 is caused to activate or deactivate.

The transceiver device 130 includes an output that is electrically coupled to the same pair of electrical terminals 210 as the pushbutton 207. In response to a barrier door control signal from the control device 150, the transceiver device 130 can provide a control signal to the barrier door operator 118 using the wired connection 132. In an example, in response to receiving the barrier door control signal, the transceiver device 130 can provide an electrical signal to, remove an electrical signal from, or complete a circuit that includes the pair of electrical terminals 210 on the barrier door operator 118, such as to mimic the operation of the pushbutton 207. In the example of FIG. 2, the transceiver device 130 provides a normally-open signal path between the pair of electrical terminals 210, and the normally-open signal path can be shunted by one or the other of the pushbutton 207 or by the transceiver device 130 (e.g., using a relay circuit included in the transceiver device 130).

In an example, barrier door operation can be configured such that when the pushbutton 207 is actuated, remote operation via the transceiver device 130 ceases. In an example, a user can be alerted via a home automation system that the pushbutton 207 for the door opener was actuated. In an example, a user can be alerted that the pushbutton 207 was actuated and that remote operation has ceased.

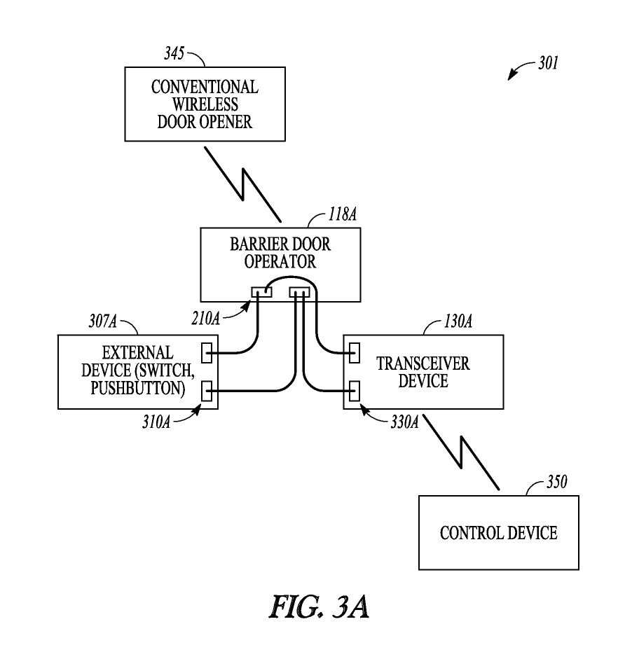

FIGS. 3A and 3B illustrate generally examples 301 and 302 of portions of a barrier door operator system according to different wiring configurations to support different operating configurations. Each of the examples 301 and 302 includes a barrier door operator (such as the barrier door operator 118), a transceiver device (such as the transceiver device 130), and an external device, such as a switch or pushbutton. Each of the examples 301 and 302 further includes a conventional wireless door opener 345 and a control device 350. The conventional wireless door opener 345 can be configured to wirelessly provide a control signal to a barrier door operator to initiate or terminate operation of a drive motor inside of the barrier door operator. The control device 350 can be configured to provide a control signal to a transceiver device, and in response, the transceiver device can selectively provide a control signal to a barrier door operator, such as to initiate or terminate operation of the drive motor inside of the barrier door operator.

In an example, the control device 350 includes a radiofrequency remote control that can be either proprietary or in compliance with a standardized communication protocol. For example, the control device 350 can include a mobile telephone, tablet computer, personal computer, laptop or notebook computer, smartphone, or other device, such as can operate a web browser or other application-specific software for interfacing with a transceiver device, such as using a WiFi or other wireless communication protocol.

In the example 301 of FIG. 3A, a transceiver device 130A is wired in parallel with an external device 307A to a barrier door operator 118A. In an example, the external device 307A includes a normally-open pushbutton, and the configuration represented in the example 301 of FIG. 3A is substantially similar to the configuration illustrated by the wiring diagram 200 of FIG. 2. In one example that includes the configuration of FIG. 3A, the barrier door operator 118A includes a control circuit that provides an electrical signal (e.g., a current or voltage) between a pair of electrical terminals 210A (e.g., using an internal resistor), and the control circuit is configured to monitor the electrical signal at the pair of electrical terminals 210A, such as for any change. If the monitored electrical signal indicates, for example, a voltage above some specified threshold voltage level, then the external device 307A and the transceiver device 130A have open circuits at their respective pairs of electrical terminals 310A and 330A, and a function of the barrier door operator 118A is unchanged. If one or both of the external device 307A or the transceiver device 130A shunts its pair of electrical terminals 310A and 330A, then the monitored voltage at the barrier door operator will be substantially zero. In response, a function of the barrier door operator 118A can be updated or changed, such as from a resting state to an operational state where a barrier door is caused to open or close.

Signals other than a voltage signal can be used. For example, an impedance or resistance characteristic at the pair of electrical terminals 210A can be used. If the barrier door operator 118A measures less than some specified threshold impedance magnitude level, then a closed-circuit condition can be indicated and a function of the barrier door operator 118A can be updated or changed. In an example, a data signal can be used, such as including a series of signal pulses that can be interpreted as a binary data signal by a control circuit in one or more of the barrier door operator 118A, the transceiver device 130A, and the external device 307A, such as for encoding a barrier door control signal.

In the example 302 of FIG. 3B, a transceiver device 130B is wired in series with an external device 307B and a barrier door operator 118B. In an example, the external device 307B includes a normally-closed pushbutton such that the electrical signal path through the external device 307B is normally shunted. Similarly to the example 301 of FIG. 3A, the barrier door operator 118B in FIG. 3B includes a control circuit that provides an electrical signal between a pair of electrical terminals 210B (e.g., using an internal resistor), and the control circuit is configured to monitor the electrical signal at the pair of electrical terminals 210B, such as for any change. In this example, if the monitored electrical signal includes a voltage that is at or near zero volts, then the series circuit from the barrier door operator 118B, to the transceiver device 130B, to the external device 307B, and back to the barrier door operator 118B is complete, and a function of the barrier door operator 118B is unchanged. If one or both of the external device 307B or the transceiver device 130B opens its pair of electrical terminals 310B and 330B, then the series electrical signal path is interrupted, and the monitored voltage at the barrier door operator will be non-zero. In response, a function of the barrier door operator 118B can be updated or changed, such as from a resting state to an operational state where a barrier door is caused to open or close.

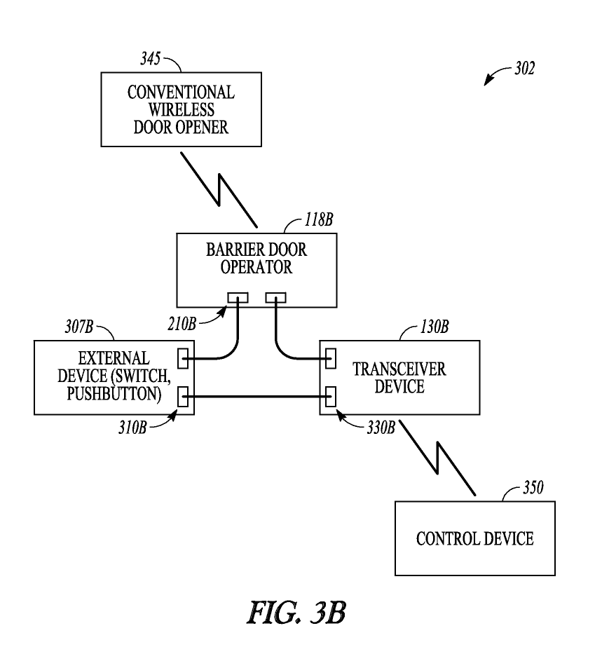

FIG. 4 illustrates generally an example of a block diagram of a system 400 that includes a transceiver device 430 and multiple sensors. The transceiver device 430 can represent generally an example of any one or more of the transceiver devices 130, 130A, or 130B discussed herein. The transceiver device 430 can include a processor circuit 401, a wireless communication circuit 402, and a data output 403. In an example, the transceiver device 430 includes an audio speaker 404 or a display 405 such as a light.

The processor circuit 401 can include a software module (e.g., code embodied (1) on a non-transitory machine-readable medium or (2) in a transmission signal) or a hardware-implemented module. A hardware-implemented module can include a tangible unit capable of performing various, programmable operations. In some examples, one or more computer systems (e.g., including a standalone, target or server computer system) or one or more processor circuits may be configured by software (e.g., an application or application portion) as a hardware-implemented module that operates to perform operations as described herein. In some examples, the hardware-implemented module can be implemented mechanically or electronically. For example, the hardware-implemented module can include dedicated circuitry or logic that is permanently configured, for example, as a special-purpose processor circuit, such as a field programmable gate array (FPGA) or an application-specific integrated circuit (ASIC), to perform specified operations. The hardware-implemented module can include programmable logic or circuitry (e.g., as encompassed within a general-purpose processor or other programmable processor) that can be temporarily configured by software to perform certain operations. The decision to implement a hardware-implemented module mechanically, in dedicated and permanently configured circuitry, or in temporarily configured circuitry (e.g., configured by software) may be driven by cost and time considerations.

The processor circuit 401 is communicatively coupled with the wireless communication circuit 402 and the data output 403. The wireless communication circuit 402 includes a wireless receiver circuit and antenna, and optionally further includes a wireless transmitter circuit. In an example, the data output 403 includes a pair of hardware electrical terminals, such as corresponding to the pairs of electrical terminals 330A and 330B in the examples of FIGS. 3A and 3B.

In an example, in operation, a barrier door control signal can be received using the wireless communication circuit 402. The barrier door control signal can be processed using the processor circuit 401, such as with information from one or more of the sensors in the example of FIG. 4, as further described below. In response the processor circuit 401 can provide a signal at the data output 403. In an example, the data output 403 includes a relay circuit that opens or closes an electrical signal path between the pair of electrical terminals included in the data output 403.

In an example, the transceiver device 430 includes one or both of the audio speaker 404 and the display 405. The audio speaker 404 can be configured to provide an audible alert in response to various triggering events, for example, in response to the transceiver device 430 issuing a control command to a barrier door operator. The display 405 can be similarly used to provide a visual alert in response to various triggering events. For example, in response to an “open door” command received at the transceiver device 430, the display 405 can illuminate a garage light. In an example, the audio speaker 404 or the display 405 can be external to the transceiver device 430, and can be communicatively coupled with the transceiver device 430 using a home automation system.

The example of FIG. 4 includes multiple sensors including a generic or user-configurable sensor 421, a tilt sensor 422 (e.g., corresponding to the tilt sensor 107), an environment sensor 423, a gas sensor 424, a temperature sensor 425, a particulate sensor 426, a proximity sensor 427, and an obstruction sensor 428 (e.g., corresponding to the obstruction sensor 105). Other sensors such as a smoke detector, infrared sensor, or water sensor can be used. The multiple sensors 421-428 can be communicatively coupled with the processor circuit 401 of the transceiver device 430. In an example, one or more of the multiple sensors 421-428 can be integrated with, or included in the same housing as, the transceiver device 430. Information from one or more of the multiple sensors 421-428 can be received and analyzed by the processor circuit 401 to determine whether the transceiver device 430 should issue a command signal to a barrier door operator.

Some examples of using information from one or more of the multiple sensors 421-428 to influence operation of a barrier door operator are provided herein. Generally, the examples include receiving sensor information using the processor circuit 401. However, in other examples, the sensor information can be communicated to the processor circuit 401 by way of one or more intermediate processor circuits or modules, such as including using other modules or portions of a home automation system.

The generic or user-configurable sensor 421 can include a microcontroller that can be user-configured with an integrated development environment. The sensor 421 can be configured to sense information from an environment, receive a user input, or receive a data signal from a home automation system module, and in response, provide a signal to the processor circuit 401.

The tilt sensor 422 can include an accelerometer, optical sensor, or other sensor configured to receive location or visual information about a barrier door. The location or visual information about the barrier door can indicate whether the barrier door is, or is likely to be, in an open, closed, or intermediate state.

The environment sensor 423 includes a sensor device that is configured to receive information characteristic of an environment parameter. An environment parameter can include, among other things, a temperature, relative humidity, brightness (e.g., for use in distinguishing between day or night), air quality, particulate count, allergen count, wind speed, ambient pressure, or ambient noise level. One or more dedicated sensors can be used to provide parameter-specific information, such as the temperature sensor 425 or the particulate sensor 426.

In an example, a gas sensor 424 can be configured to sense information about a presence of a gas in an environment, such as carbon monoxide or carbon dioxide gas. The gas sensor 424 can communicate information about the presence of a particular gas or gasses to the processor circuit 401, and in response, the processor circuit 401 can conditionally provide a barrier door control signal at the data output 403. For example, the gas sensor 424 can be positioned in an indoor garage. If the gas sensor 424 indicates an ambient concentration of carbon monoxide gas that exceeds a specified threshold concentration, then the processor circuit 401 can provide a barrier door control signal at the data output 403 to open a barrier door to vent the garage. In an example, if the gas sensor 424 indicates an ambient concentration of carbon monoxide gas that exceeds the specified threshold concentration after issuing the barrier door control signal, then the processor circuit 401 can communicate a warning, such as using the audio speaker 404, the display 405, or by communicating with another module in a home automation system that is communicatively coupled with the transceiver device 430. In an example, the gas sensor 424 can be configured to sense information about one or more of propane, natural gas, or other substances.

The proximity sensor 427 can be configured to sense information about proximity of a vehicle or other object to the sensor itself. For example, the proximity sensor 427 can be used in a garage to help a driver determine when his or her vehicle is too close to a wall or other object in the garage. If the proximity sensor 427 indicates that the vehicle is too close to the wall, for example, then the processor circuit 401 can generate an alert using the transceiver device 430, such as by sounding an alarm using the audio speaker 404, or by providing a visual alert (e.g., a flashing light) using the display 405, such as to alert the driver. In an example, the proximity sensor 427 is integrated with the vehicle, and the proximity sensor 427 communicates with the transceiver device 430 using the wireless communication circuit 402 when the proximity sensor 427 is within range.

In an example, the transceiver device 430 can be operated based upon remote user proximity information. The proximity information can take the form of geo-fencing information such as from a cellular telephone network such as can be communicated to the transceiver device 430 through a home automation system or other communication hub. Additionally or alternatively to using a dedicated proximity sensor, the transceiver device 430 can use information from a radio, such as using any one of a variety of wireless protocols, such as including but not limited to Bluetooth low energy or Near Field Communications, to determine a user's proximity to the transceiver device 430. In an example, the proximity sensor 427 includes an RFID tag and the transceiver device 430 can receive information from the RFID tag when the tag is within range.

The obstruction sensor 428 can include an optical sensor that is configured to sense the presence of an obstruction in an area where a barrier door is expected to travel. In response to a detected presence or absence of an obstruction, the obstruction sensor 428 can provide a signal to the processor circuit 401. For example, if an obstruction is present, then the obstruction sensor 428 can provide a signal to the processor circuit 401 that indicates the presence of an obstruction. The processor circuit 401 can then determine whether to halt, reverse, or slow movement of the barrier door.

In an example, the transceiver device 430 includes a memory circuit. The memory circuit can optionally be included as a portion of a home automation system that is remote from the transceiver device 430. The memory circuit can log barrier door operator or activity information or sensor information, such as for security or device-learning purposes. Such information can include time and/or manner of door opening information, such as by tracking one or more opening commands exchanged between a transceiver device and a control device, as well as one or more commands received from a local pushbutton or switch. In an example in which door opening is controlled by manual operation or a radio-frequency remote control device, tilt sensor data, as compared against one or more commands from the remote control device and the local pushbutton, can be used to determine whether a barrier door was operated at a particular time by a particular mode of operation.

In an example, the transceiver device 430, such as operating in coordination with the tilt sensor 422, can record a variety of door-opening analytic information. One or more similar analytic characteristics may be recorded with one or more other barrier door position sensing techniques. For example, by recording a duration time for a barrier door to open or close, the transceiver device 430 (or other processing module configured to receive and interpret the analytic information) can provide one or more door opener diagnostics, troubleshooting information, and/or alerts for a user. For example, the transceiver device 430 can use the analytic information to identify a problem with one or more of a barrier door operator, a track, or a linkage. In response, the device can send a remote user an alert identifying the issue. In an example, the transceiver device 430 can use analytic information to determine the size of a barrier door, the travel distance of a barrier door, and/or one or more other factors for use in an automated barrier door function.

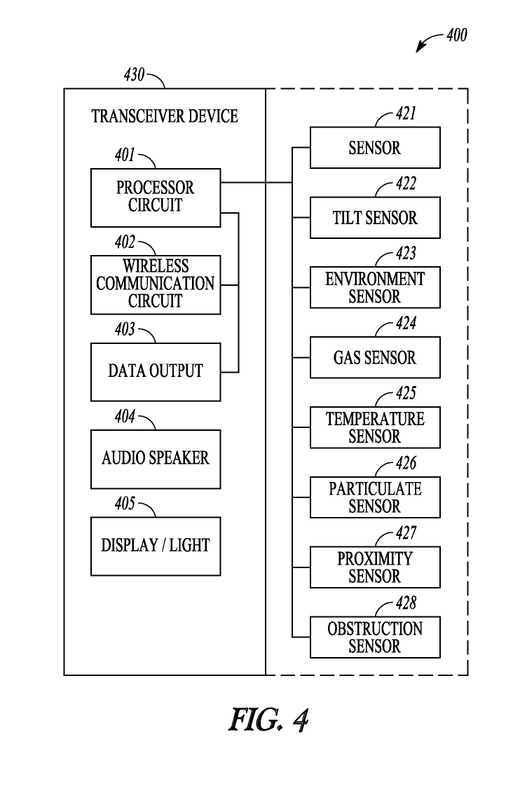

FIG. 5 illustrates generally an example of a state diagram for a barrier door operator system. The following discussion of FIG. 5 makes reference to the system 100 of FIG. 1 and its components. At state 0, the barrier door 110 is stationary, in a closed or down position, and the barrier door operator 118 is not attempting to raise or lower the barrier door 110. In the example of FIG. 5, the system 100 can transition from state 0 to state 1 or to state 4.

In an example, state 0 transitions to state 1 in response to an “open” request received at the transceiver device 130. At state 1, an audible or visual alert can be generated, such as using the audio speaker 404 or the display 405. In response to the “open” request, an “open warning” timer can be initiated using a timer circuit. The timer circuit can be included in the transceiver device 130 or in another module or circuit of a home automation system that is coupled to the transceiver device 130. In an example one or more alerts can be issued or other functions performed upon expiration of the “open warning” timer. The one or more alerts or other functions can be conditioned on one or more other events occurring before expiration of the timer. In the example of FIG. 5, the system 100 can transition from state 1 to any of states 0, 2, 3, or 4.

In an example, state 0 transitions to state 4 in response to an “open” or “horizontal” signal is received from the tilt sensor 107. At state 4, the barrier door 110 is determined to be in a position other than fully closed. At state 4, the barrier door 110 can be in the process of opening or closing, or the barrier door 110 can be stopped in an intermediate position. In the example of FIG. 5, the system 100 can transition from state 4 to state 0 or state 1. If, after state 4, the tilt sensor 107 indicates or provides a “closed” signal, then the system 100 is in state 0.

If, after state 4, a “close” request is received at the transceiver device 130, then the system 100 can initiate a barrier door close sequence. In an example, the barrier door close sequence can include issuing a barrier door command signal from the transceiver device 130 to the barrier door operator 118. The barrier door close sequence can include initiating a timer using a timer circuit, such as described above. In an example, a “close warning” timer can be initiated using a timer circuit in response to the “close” request.

In an example, state 1 transitions to state 4 in response to an “open” or “horizontal” signal that is received from the tilt sensor 107. In another example, state 1 transitions to state 0 in response to a “closed” or “vertical” signal that is received from the tilt sensor 107. When the tilt sensor 107 indicates that the barrier door 110 is fully closed in state 0, or indicates that the barrier door 110 is not fully closed in state 4, then any active timers can be canceled.

In an example, state 1 transitions to state 2 if the “open warning” timer expires, and an “open” timer can be initiated. At state 2, the system 100 can hold for a “closed” state message, such as from the tilt sensor 107. In the example of FIG. 5, the system 100 can transition from state 2 to state 0 or state 4. For example, state 2 can transition to state 0 if a “closed” or “vertical” message is received from the tilt sensor 107. Alternatively, state 2 can transition to state 0 if the “open” timer expires. If the “open” timer expires, then the barrier door 110 is determined to have failed to open. At state 2, if an “open” or “horizontal” message is received from the tilt sensor 107, then the “open” timer can be canceled and the system 100 transitions to state 4.

In an example, state 1 transitions to state 3 if the “close warning” timer expires, and a “close” timer can be initiated. At state 3, the system 100 can hold for a “closed” state message, such as from the tilt sensor 107. In the example of FIG. 5, the system 100 can transition from state 3 to state 0 or state 4. For example, state 3 can transition to state 0 if a “closed” message is received from the tilt sensor 107. Alternatively, state 3 can transition to state 4 if an “open” or “horizontal” message is received from the tilt sensor 107. In an example, state 3 can transition to state 4 if the “close” timer expires. If the “close” timer expires, then the barrier door 110 is determined to have failed to close.

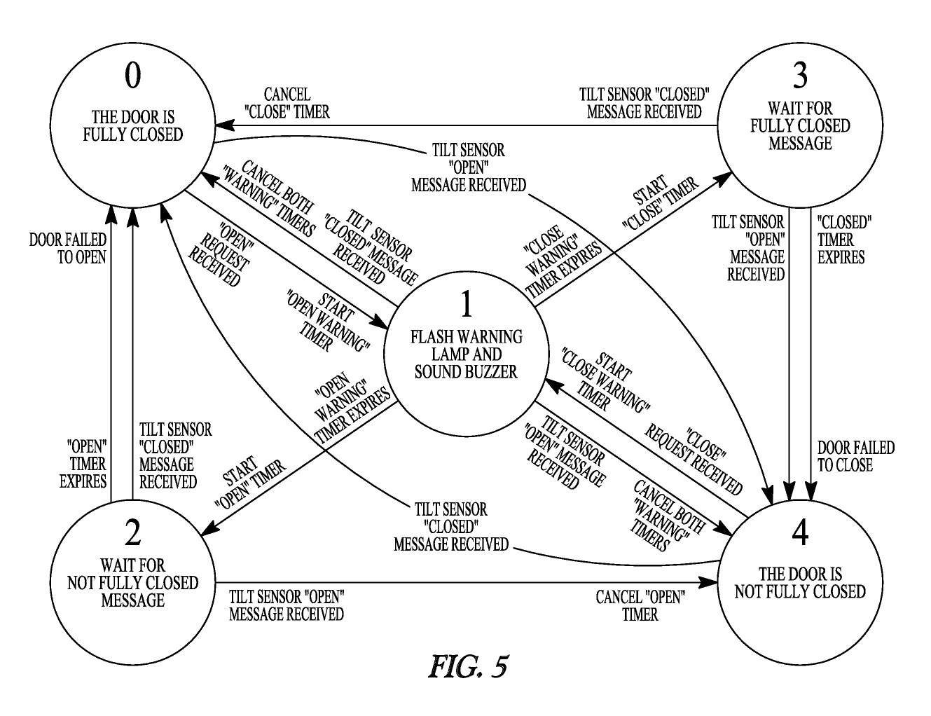

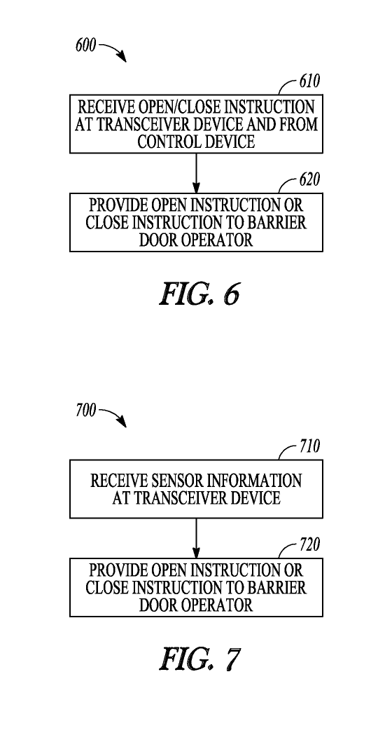

Referring now to FIGS. 6 and 7, other examples of methods of using a transceiver device with a barrier door are described. FIG. 6 illustrates generally an example of a first method 600 that includes operating a barrier door using information from a transceiver. At 610, the method includes receiving a barrier door command at a transceiver device. Receiving the barrier door command can include receiving an “open” or “close” command from a user using a control device, such as the control device 150 in the example of FIG. 1. The barrier door command can include a wireless signal or code that is received by the transceiver device 130.

At 620, in response to receiving the barrier door command at 610, the method includes providing a barrier door control signal to a barrier door operator. For example, in response to an “open” command received at 610, the transceiver device 130 can issue a signal to the barrier door operator 118 to open the barrier door 110. In an example, issuing the signal can include using a circuit in the transceiver device 130 to open or close an electrical circuit that includes terminals of the barrier door operator 118 that are generally configured for use with a conventional normally-open or normally-closed single-pole pushbutton. In response to receiving the signal from the transceiver device 130 at the barrier door operator 118, the barrier door operator 118 can be caused to initiate a drive motor and open or close the barrier door.

FIG. 7 illustrates generally an example of a second method 700 that includes operating a barrier door using sensor information. At 710, the method includes receiving sensor information at a transceiver device. Receiving the sensor information can include receiving information about an environment parameter, information about an opened or closed status of a barrier door, information about time of day, or other information that can be used to influence operation of a barrier door. In an example, the sensor information can be received using one or more of the multiple sensors 421-428 discussed above in the example of FIG. 4. The sensor information can be received by way of wired or wireless data communication between a sensor device and the transceiver device, or one or more other intermediate or relay devices can be used. In an example, the sensor information is received using one or more sensors that form a portion of a home automation system, and the transceiver device is communicatively coupled with the home automation system.

At 720, in response to receiving the sensor information at 710, the method includes providing a barrier door control signal to a barrier door operator. For example, in response to an elevated temperature sensed using a temperature sensor at 610, the transceiver device 130 can issue a signal to the barrier door operator 118 to open the barrier door 110. In an example, issuing the signal can include using a circuit in the transceiver device 130 to open or close an electrical circuit that includes terminals of the barrier door operator 118 that are generally configured for use with a pushbutton. In response to receiving the signal from the transceiver device 130 at the barrier door operator 118, the barrier door operator 118 can be caused to initiate a drive motor and open or close the barrier door.

### Various Notes & Examples

Example 1 can include or use subject matter (such as an apparatus, a method, a means for performing acts, or a device readable medium including instructions that, when performed by the device, can cause the device to perform acts), such as can include or use a transceiver device for controlling a barrier door using a barrier door operator, wherein the barrier door operator is separate from the transceiver device. The transceiver device can include a processor circuit, a wireless communication circuit configured to receive a door operation instruction from a control device that is remote from the transceiver device, and a data output terminal configured to provide a control signal to a terminal of the barrier door operator. The terminal of the barrier door operator can be configured to be wired to a remote pushbutton device, and the control signal can be configured to instruct the barrier door operator to open or close the barrier door. In Example 1, the processor circuit can be configured to provide the control signal to the data output terminal based on the door operation instruction received using the wireless communication circuit.

Example 2 can include, or can optionally be combined with the subject matter of Example 1, to optionally include at least one sensor configured to sense information about a status of the barrier door. In Example, 2, the wireless communication circuit can be configured to receive barrier door status information from the at least one sensor, and the processor circuit can be configured to provide the control signal to the data output terminal based on (1) the door operation instruction received using the wireless communication circuit, and (2) the received barrier door status information from the at least one sensor.

Example 3 can include, or can optionally be combined with the subject matter of Example 2, to optionally include a memory circuit configured to store information about a status of the barrier door, wherein in response to a door open instruction from the control device, the processor circuit can be configured to initiate a first timer having a first duration, receive barrier door status information from the at least one sensor, and if the barrier door status information indicates that the barrier door is fully open before the first duration expires, then cancel the first timer and store, in the memory circuit, an indication that the barrier door is fully open. In Example 3, if the barrier door status information indicates that the barrier door is not fully open before the first duration expires, then the processor circuit can be configured to store, in the memory circuit, an indication that the barrier door is other than fully open.

Example 4 can include, or can optionally be combined with the subject matter of Example 2, to optionally include memory circuit configured to store information about a status of the barrier door, wherein in response to a door close instruction from the control device, the processor circuit is configured to initiate a second timer having a second duration, receive barrier door status information from the at least one sensor, and if the barrier door status information indicates that the barrier door is fully closed before the second duration expires, then cancel the second timer, and store, in the memory circuit, an indication that the barrier door is fully closed. In Example 4, if the barrier door status information indicates that the barrier door is not fully closed before the second duration expires, then the processor circuit can be configured to store, in the memory circuit, an indication that the barrier door is other than fully closed.

Example 5 can include, or can optionally be combined with the subject matter of one or any combination of Examples 1 through 4 to optionally include at least one of an audio speaker or a visual display, wherein in response to a door open instruction or a door close instruction from the control device, the processor circuit can be configured to initiate an audible or visual alert using the at least one of the audio speaker or the visual display. In Example 5, the alert can be initiated before the processor circuit provides the control signal to the data output terminal based on the door open instruction.

Example 6 can include, or can optionally be combined with the subject matter of one or any combination of Examples 1 through 5 to optionally include the wireless communication circuit configured to receive the door operation instruction from the control device using one or more of a Z-wave, Zigbee, IP, WiFi, Bluetooth, or other (e.g., proprietary) communication protocol.

Example 7 can include, or can optionally be combined with the subject matter of one or any combination of Examples 1 through 6 to optionally include an environment sensor configured to sense information about an environment around or near the device, and configured to provide a signal indicative of the sensed environment information to the processor circuit. In Example 7, the processor circuit can be configured to provide the control signal to the data output terminal based on (1) the door operation instruction received using the wireless communication circuit, and (2) the sensed environment information around or near the device.

Example 8 can include, or can optionally be combined with the subject matter of Example 7, to optionally include, as the environment sensor, at least one of (1) a temperature sensor configured to sense information about an ambient temperature in the vicinity of the barrier door, (2) a gas sensor configured to sense information about a presence of one or more of carbon monoxide gas, natural gas, or propane gas, in the vicinity of the barrier door, and (3) a particulate or air quality sensor configured to sense information about a presence of smoke or other particulate matter in the vicinity of the barrier door.

Example 9 can include, or can optionally be combined with the subject matter of one or any combination of Examples 1 through 8 to optionally include, at the data output terminal, a pair of electrical contacts that are configured to be electrically coupled in parallel with a corresponding pair of electrical contacts at the terminal of the barrier door operator that is configured to be wired to the remote pushbutton device.

Example 10 can include, or can optionally be combined with the subject matter of one or any combination of Examples 1 through 8 to optionally include, at the data output terminal, a pair of electrical contacts that are configured to be electrically coupled in series with the terminal of the barrier door operator that is configured to be wired to the remote pushbutton device.

Example 11 can include, or can optionally be combined with the subject matter of one or any combination of Examples 1 through 10 to optionally include the wireless communication circuit configured to receive the door operation instruction from a second wireless communication circuit in a controller of a home automation system.

Example 12 can include, or can optionally be combined with the subject matter of one or any combination of Examples 1 through 11 to optionally include a user proximity sensor configured to sense information about a distance between an authorized user and the barrier door, and configured to provide a signal indicative of the sensed distance information to the processor circuit. In Example 12, the processor circuit can be configured to provide the control signal to the data output terminal using the signal indicative of the sensed distance information from the user proximity sensor.

Example 13 can include or use subject matter (such as an apparatus, a method, a means for performing acts, or a device readable medium including instructions that, when performed by the device, can cause the device to perform acts), such as can include or use a system for controlling operation of a barrier door. Example 13 can include a transceiver device having a processor circuit, a wireless communication circuit configured to receive a door operation instruction from a control device that is remote from the transceiver device, and a data output terminal configured to provide a control signal to a data input terminal of a barrier door operator, the control signal including an instruction for the barrier door operator to open or close the barrier door. Example 13 can include or use a user proximity sensor to sense information about a distance between an authorized user and the barrier door, and configured to provide a signal indicative of the sensed distance information to the processor circuit. Example 13 can include or use a tilt sensor configured to sense a barrier door position, and configured to provide a signal indicative of the barrier door position to the processor circuit. Example 13 can include an environment sensor configured to sense environment information at or near the device, and configured to provide a signal indicative of the sensed environment information to the processor circuit. The processor circuit of Example 13 can be configured to provide the control signal to the data output terminal based on one or more of (1) the door operation instruction received using the wireless communication circuit, (2) the signal indicative of the sensed environment information from the environment sensor, (3) the signal indicative of the barrier door position from the tilt sensor, and (4) the signal indicative of the sensed distance information from the user proximity sensor, such as depending on the availability or inclusion of the user proximity, tilt, and environment sensors.

Example 14 can include or use subject matter (such as an apparatus, a method, a means for performing acts, or a device readable medium including instructions that, when performed by the device, can cause the device to perform acts), such as can include or use a remote-controlled door operator system for moving a barrier door. The system of Example 14 can include an automated door opener configured to open or close a barrier door in response to a signal from an external switch. The automated door opener can include a data input configured to receive the signal from the external switch, the data input including a first pair of electrical terminals, and a lift mechanism configured to provide a force for opening or closing the barrier door in response to the signal received at the data input. Example 14 can include a tilt sensor configured to sense barrier door position information about the barrier door, and a transceiver device, including a data output with a second pair of electrical terminals configured to be coupled in parallel with the first pair of electrical terminals on the automated door opener. The transceiver device can be configured to wirelessly receive a barrier door open instruction or a barrier door close instruction from a control device, and, using the sensed barrier door position information from the tilt sensor and in response to the received barrier door open or close instruction, provide a control signal to the data input of the automated door opener to instruct the automated door opener to move the barrier door.

Example 15 can include, or can optionally be combined with the subject matter of Example 14, to optionally include the control device, wherein the control device includes one or more of a home automation system component, a smartphone, or other handheld communication device.

Example 16 can include, or can optionally be combined with the subject matter of one or any combination of Examples 14 or 15 to optionally include the external switch, wherein the external switch includes a two-wire normally-open or normally-closed switch device.

Example 17 can include, or can optionally be combined with the subject matter of one or any combination of Examples 14 through 16 to optionally include the automated door opener being configured to open or close the barrier door, such as including a garage door opener configured to open or close a garage door.

Example 18 can include, or can optionally be combined with the subject matter of one or any combination of Examples 14 through 17 to optionally include at least one of (1) a user proximity sensor configured to sense distance information about a distance between an authorized user and the barrier door, and (2) an environment sensor configured to sense environment information at or near the transceiver device. In Example 18, the transceiver device can be configured to provide the control signal to the data input of the automated door opener based on at least one of the sensed distance information and the sensed environment information at or near the transceiver device.

Example 19 can include or use subject matter (such as an apparatus, a method, a means for performing acts, or a device readable medium including instructions that, when performed by the device, can cause the device to perform acts), such as can include or use a method for wirelessly controlling a barrier door using a transceiver device communicatively coupled to a barrier door operator. Example 19 can include wirelessly receiving an instruction at a transceiver device, from a wireless remote control device, to open or close the barrier door, receiving barrier door position information from a tilt sensor, and communicating an instruction to open or close the barrier door to the barrier door operator. The communicated instruction can be based on the received instruction from the control device and the received barrier door position information from the tilt sensor. In Example 19, communicating the instruction can include providing an electrical signal via a wired connection from the transceiver device to a pair of electrical contacts located at the barrier door operator, and the pair of electrical contacts located at the barrier door operator can be configured to receive a barrier door control signal from a wired pushbutton.

Example 20 can include, or can optionally be combined with the subject matter of Example 19 to optionally include wirelessly receiving the instruction at the transceiver device from the wireless remote control device includes using one or more of a Z-wave, Zigbee, IP, WiFi, Bluetooth, or other (e.g., proprietary) communication protocol.

Each of these non-limiting examples can stand on its own, or can be combined in various permutations or combinations with one or more of the other examples.

In the event of inconsistent usages between this document and any documents so incorporated by reference, the usage in this document controls.

Method examples described herein can be machine or computer-implemented at least in part. For example, the processor circuit 401, or some other controller or processor circuit, can be used to implement at least a portion of one or more of the methods discussed herein. Some examples can include a tangible, computer-readable medium or machine-readable medium encoded with instructions that are operable to configure an electronic device to perform methods as described in the above examples. An implementation of such methods can include code, such as microcode, assembly language code, a higher-level language code, or the like. Such code can include computer-readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A transceiver device for controlling a barrier door using a barrier door operator, the barrier door operator separate from the transceiver device, the transceiver device comprising:
a processor circuit;
a wireless communication circuit configured to receive a door operation instruction from a control device that is remote from the transceiver device; and
a data output terminal configured to provide a control signal to a terminal of the barrier door operator, the terminal of the barrier door operator configured to be wired to a remote pushbutton device, and the control signal instructing the barrier door operator to open or close the barrier door;
wherein the processor circuit is configured to provide the control signal to the data output terminal based on the door operation instruction received using the wireless communication circuit.

2. The transceiver device of claim 1, comprising at least one sensor configured to sense information about a status of the barrier door;
wherein the wireless communication circuit is configured to receive barrier door status information from the at least one sensor; and
wherein the processor circuit is configured to provide the control signal to the data output terminal based on (1) the door operation instruction received using the wireless communication circuit, and (2) the received barrier door status information from the at least one sensor.

3. The device of claim 2, comprising a memory circuit configured to store information about a status of the barrier door, wherein in response to a door open instruction from the control device, the processor circuit is configured to:
initiate a first timer having a first duration;
receive barrier door status information from the at least one sensor; and
if the barrier door status information indicates that the barrier door is fully open before the first duration expires, then:
cancel the first timer; and
store, in the memory circuit, an indication that the barrier door is fully open; and
if the barrier door status information indicates that the barrier door is not fully open before the first duration expires, then store, in the memory circuit, an indication that the barrier door is other than fully open.

4. The device of claim 2, comprising a memory circuit configured to store information about a status of the barrier door, wherein in response to a door close instruction from the control device, the processor circuit is configured to:
initiate a second timer having a second duration;
receive barrier door status information from the at least one sensor; and
if the barrier door status information indicates that the barrier door is fully closed before the second duration expires, then:
canceling the second timer; and
storing, in the memory circuit, an indication that the barrier door is fully closed; and
if the barrier door status information indicates that the barrier door is not fully closed before the second duration expires, then storing, in the memory circuit, an indication that the barrier door is other than fully closed.

5. The device of claim 1, comprising at least one of an audio speaker or a visual display, wherein in response to a door open instruction or a door close instruction from the control device, the processor circuit is configured to initiate an audible or visual alert using the at least one of the audio speaker or the visual display, the alert initiated before the processor circuit provides the control signal to the data output terminal based on the door open instruction.

6. The device of claim 1, wherein the wireless communication circuit is configured to receive the door operation instruction from the control device using one or more of a Z-wave, Zigbee, IP, WiFi, or Bluetooth communication protocol.

7. The device of claim 1, comprising an environment sensor configured to sense information about an environment around or near the device, and configured to provide a signal indicative of the sensed environment information to the processor circuit;
wherein the processor circuit is configured to provide the control signal to the data output terminal based on (1) the door operation instruction received using the wireless communication circuit, and (2) the sensed environment information around or near the device.

8. The device of claim 7, wherein the environment sensor includes one of:
a temperature sensor configured to sense information about an ambient temperature in the vicinity of the barrier door;
a gas sensor configured to sense information about a presence of one or more of carbon monoxide gas, natural gas, or propane gas, in the vicinity of the barrier door; and
a particulate or air quality sensor configured to sense information about a presence of smoke or other particulate matter in the vicinity of the barrier door.

9. The device of claim 1, wherein the data output terminal includes a pair of electrical contacts that are configured to be electrically coupled in parallel with a corresponding pair of electrical contacts at the terminal of the barrier door operator that is configured to be wired to the remote pushbutton device.

10. The device of claim 1, wherein the data output terminal includes a pair of electrical contacts that are configured to be electrically coupled in series with the terminal of the barrier door operator that is configured to be wired to the remote pushbutton device.

11. The device of claim 1, wherein the wireless communication circuit is configured to receive the door operation instruction from a second wireless communication circuit in a controller of a home automation system.

12. The device of claim 1, comprising a user proximity sensor configured to sense information about a distance between an authorized user and the barrier door, and configured to provide a signal indicative of the sensed distance information to the processor circuit;
wherein the processor circuit is configured to provide the control signal to the data output terminal using the signal indicative of the sensed distance information from the user proximity sensor.

13. A system for controlling operation of a barrier door, the system comprising:
a transceiver device, comprising:
a processor circuit;
a wireless communication circuit configured to receive a door operation instruction from a control device that is remote from the transceiver device; and
a data output terminal configured to provide a control signal to a data input terminal of a barrier door operator, the control signal including an instruction for the barrier door operator to open or close the barrier door;
a user proximity sensor configured to sense information about a distance between an authorized user and the barrier door, and configured to provide a signal indicative of the sensed distance information to the processor circuit;
a tilt sensor configured to sense a barrier door position, and configured to provide a signal indicative of the barrier door position to the processor circuit; and
an environment sensor configured to sense environment information at or near the device, and configured to provide a signal indicative of the sensed environment information to the processor circuit;
wherein the processor circuit is configured to provide the control signal to the data output terminal based on one or more of (1) the door operation instruction received using the wireless communication circuit, (2) the signal indicative of the sensed environment information from the environment sensor, (3) the signal indicative of the barrier door position from the tilt sensor, and (4) the signal indicative of the sensed distance information from the user proximity sensor.

14. A remote-controlled door operator system for moving a barrier door, the system comprising:
an automated door opener configured to open or close a barrier door in response to a signal from an external switch, the automated door opener including:
a data input configured to receive the signal from the external switch, the data input including a first pair of electrical terminals; and
a lift mechanism configured to provide a force for opening or closing the barrier door in response to the signal received at the data input;
a tilt sensor configured to sense barrier door position information about the barrier door; and
a transceiver device, including a data output with a second pair of electrical terminals configured to be coupled in parallel with the first pair of electrical terminals on the automated door opener, the transceiver device configured to:
wirelessly receive a barrier door open instruction or a barrier door close instruction from a control device, and
using the sensed barrier door position information from the tilt sensor and in response to the received barrier door open or close instruction, provide a control signal to the data input of the automated door opener to instruct the automated door opener to move the barrier door.

15. The system of claim 14, comprising the control device, wherein the control device includes one or more of a home automation system component, a smartphone, or other handheld communication device.

16. The system of claim 14, comprising the external switch, wherein the external switch includes a two-wire normally-open switch device.

17. The system of claim 14, wherein the automated door opener configured to open or close the barrier door includes a garage door opener configured to open or close a garage door.

18. The system of claim 14, comprising at least one of:
a user proximity sensor configured to sense distance information about a distance between an authorized user and the barrier door; and
an environment sensor configured to sense environment information at or near the transceiver device;
wherein the transceiver device is configured to provide the control signal to the data input of the automated door opener based on at least one of the sensed distance information and the sensed environment information at or near the transceiver device.

19. A method for wirelessly controlling a barrier door using a transceiver device communicatively coupled to a barrier door operator, the method comprising:
wirelessly receiving an instruction at a transceiver device, from a wireless remote control device, to open or close the barrier door;
receiving barrier door position information from a tilt sensor; and
communicating an instruction to open or close the barrier door to the barrier door operator, the communicated instruction based on the received instruction from the control device and the received barrier door position information from the tilt sensor;
wherein the communicating the instruction includes providing an electrical signal via a wired connection from the transceiver device to a pair of electrical contacts located at the barrier door operator, the pair of electrical contacts located at the barrier door operator configured to receive a barrier door control signal from a wired pushbutton.

20. The method of claim 19, wherein the wirelessly receiving the instruction at the transceiver device from the wireless remote control device includes using one or more of a Z-wave, Zigbee, IP, WiFi, or Bluetooth communication protocol.
